(19) United States
(12) Patent Application Publication
(10) Pub. No.: US 2015/0173375 A1
(43) Pub. Date: Jun. 25, 2015

(54) HIGH PROTEIN BREAD FORMULATION

(71) Applicant: Young Living Essential Oils, LC, Lehi, UT (US)

(72) Inventor: D. Gary Young, Alpine, UT (US)

(21) Appl. No.: 14/576,732

(22) Filed: Dec. 19, 2014

Related U.S. Application Data
(60) Provisional application No. 61/918,061, filed on Dec. 19, 2013.

(51) Int. Cl. A21D 10/00

(52) U.S. Cl. CPC A21D 10/005

(57) ABSTRACT

The present invention relates to a high protein bread and bread mixtures which include novel combinations of obscure ingredients.

### CROSS-REFERENCES TO RELATED APPLICATIONS

This application claims the benefit of U.S. Provisional Application No. 61/918,061 entitled “High Protein Bread Formulation” and filed on Dec. 19, 2013, which is incorporated herein by reference in its entirety.

### BACKGROUND

The present invention relates to high protein breads comprising ingredients which may be derived from non-genetically modified organisms (non-GMOs). In particular, the present invention relates to bread formulations which combine obscure, high-protein ingredients to provide dry bread mixtures, dough, and batters that may be used to produce breads that are high in protein, including pancakes.

Bread is a staple food prepared by baking a dough or batter that largely consists of flour and water. Bread is popular around the world and is considered one of the world's oldest foods. As a staple food, the nutritional value of bread is important. The nutritional value of bread has traditionally been determined based upon the bread's protein content. Breads made with higher protein grain comprise higher nutritional value, while breads made with lower protein grain are less nutritional. Higher protein grains also have a tendency to make the texture of the bread heartier, and therefore less desirable to consumer's that desire a light textured bread. The hearty texture imparted from high protein grains is also undesirable for breads that are intended to have light and fluffy textures, such as pancakes.

Thus, although formulations currently exist that produce breads having high protein content, challenges still exist. Thus, it would be an improvement in the art to augment or replace current formulations and ingredients with the formulations and ingredients discussed herein.

### SUMMARY

The present invention relates to high protein breads. In particular, the present invention relates to bread formulations which combine obscure, high-protein, and/or non-GMO ingredients to provide dry bread mixtures, dough, and batters that may be used to produce breads that are high in protein, including pancakes.

In some aspects, the invention comprises a bread formulation which includes a unique combination of obscure ingredients that provide a high-protein bread having a light texture that is suitable for use in providing pancakes, waffles, and other light-textured breads. In some instances, a bread formulation is provided comprising a mixture of einkhorn wheat flour, golden moong flour, dhokla flour, and amaranth seed flour. In other instances, a bread formulation is provided comprising a mixture of one or more of einkhorn wheat flour, golden moong flour, dhokla flour, amaranth seed flour, brown rice flour, and corn flour. Other formulations herein further comprise tapioca flour.

Some formulations of the present invention further comprise one or more sweeteners selected from the group consisting of cane juice, cane juice crystals, refined white sugar, stevia, and agave nectar. A dry mixture formulation may include one or more dry sweeteners selected from the group consisting of cane juice crystals, refined white sugar, sucanat, rapidura, date sugar, maple sugar, raw sugar, jiggery, palm sugar, stevia, and natural brown sugar.

The ingredients of the various formulations of the present invention may be combined in any ratio that provides a bread having the desired nutritional content and texture discussed herein. In some instances, a formulation for a bread mix is provided wherein the einkhorn wheat flour represents approximately 16-30% v/v of the mixture, the corn flour represents approximately 16-30% v/v of the mixture, the golden moong flour represents approximately 5-20% v/v of the composition, the dhokla flour represents approximately 5-20% of the mixture, and the amaranth seed flour represents approximately 1-15% of the mixture.

Some formulations of the instant invention provide a bread mix that may be packaged, labeled and sold. For example, a bread mix may be packaged, labeled and sold as a dry pancake mixture. In some instances, the bread mix or dry pancake mixture is combined with additional ingredients to provide bread dough or pancake batter. For example, the bread mix may be combined with one or more ingredients selected from the group consisting of eggs, water, milk, butter, coconut oil, vegetable oil, macadamia nut oil, and vanilla extract.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### DETAILED DESCRIPTION

This specification describes exemplary embodiments and applications of the invention. The invention, however, is not limited to these exemplary embodiments and application or to the manner in which the exemplary embodiments and applications operate or are described herein. Where reference is made to a list of elements or ingredients, such reference is intended to include any one of the listed elements by itself, any combination of less than all of the listed ingredients, and/or a combination of all the listed ingredients.

Numerical data may be expressed or presented herein in a range format. It is to be understood that such a range format is used merely for convenience and brevity and thus should be interpreted flexibly to include not only the numerical values explicitly recited as the limits of the range, but also as including all the individual numerical values or sub-ranges encompassed within that range as if each numerical value and sub-range is explicitly recited. As an illustration, a numerical range of “about 1 to 5” should be interpreted to include not only the explicitly recited values of about 1 to 5, but also include individual values and sub-ranges within the indicated range. Thus, included in this numerical range are individual values such as 2, 3, and 4 and sub-ranges such as 1-3, 2-4, and 3-5, etc., as well as sub-ranges such as 2.2, 2.3, 2.4, etc. This same principle applies to ranges reciting only one numerical value and should apply regardless of the breadth of the range or the characteristics being described.

The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The present invention relates generally to high protein breads comprising ingredients that may be derived from non-genetically modified organisms (non-GMOs). In particular, the present invention relates to bread formulations which combine obscure, high-protein, non-GMO ingredients to provide dry bread mixtures, dough, and batters that may be used to produce breads that are high in protein, including pancakes.

In some embodiments, the invention comprises a bread formulation which includes a unique combination of obscure ingredients that provide a high-protein bread having a light texture that is suitable for use in providing pancakes, waffles, and other light-textured breads. Generally, the ingredients of the invention are derived from natural, non-GMOs sources which have been selected based upon their nutritional profiles. For example, the various ingredients of the present invention were selected based upon their high protein content, gluten characteristics, fiber content, starch content, and GMO status.

Some formulations of the present invention comprise einkhorn wheat flour. Einkhorn wheat can include either the wild speciese of wheat, Triticum boeoticum, or to the domesticated form, Triticum monococcum (also known as einkorn farro). Einkhorn wheat is one of the earliest cultivated forms of wheat and is generally believed, to date, to be a non-GMO. Einkorn wheat has a very simple diploid genetic structure, with only 14 chromosomes compared with common/modern wheat, which contains 42 chromosomes. Einkorn wheat may thus provide numerous nutritional benefits over other types of wheat. For example, some scientist have found that einkorn is higher in Vitamin A beta-carotene, lutein, and riboflavin than common/modern wheat. Einkhorn wheat also contains gliadin protein which has demonstrated decreased toxicity to suffers of coeliac disease. Thus, in some instances the present invention provides a formulation for a high protein bread for use in a gluten-free diet, wherein the bread formulation comprises einkhorn wheat flour.

Some formulations of the present invention further comprise flour from moong dal (also known as green pea, hoon kway, mung bean, and golden moong) beans, which is native to the Indian subcontinent. Moong beans (the seed of Vigna radiate) are naturally high in protein, potassium, fiber, magnesium, and vitamin B. They are generally low in calories, with one cup of these bean (about 250 ml) having less than 30 calories. Moong dal beans are generally believed to be non-GMO, to date. Moong dal flour is a refined, cream-colored flour which is processed from hulled moong dal. Moong dal flour is naturally gluten-free, high in protein and has desirable starch properties.

Various formulations of the instant invention further comprise dhokla flour. Dhokla flour comprises a 3:1 ratio of ground rice and urad dal bean. As both rice and urad dal bean are gluten-free, formulations of the present invention comprising dhokla flour may be used in gluten-free diets. Further, the high protein content of rice and urad dal bean are desirable for providing high protein breads in accordance with the present invention.

Some formulations of the present invention further comprise amaranth seed flour. Amaranth is a gluten-free food and a source of complete protein. Amaranth further contains all the essential amino acids, including lysine, which is typically absent in most grains. Amaranth is also high in fiber and a good source of magnesium and iron.

In some instances, the present invention comprises one or more formulations that further include brown rice flour, and/or corn flour. Both of these flours are gluten-free, and brown rice flour is high in protein, iron, fiber and vitamin B. Corn flour contains starches that are beneficial as fillers, binders and thickeners for breads of the instant invention.

Various formulations of the instant invention may further include tapioca flour and/or Khorasan wheat flour. Tapioca flour, also known as tapioca starch, is a starchy white flour that has a slightly sweet flavor. Tapioca flour acts as a binder to improve the texture of the bread. Tapioca flour further adds crispness to crusts, and increases the toughness or chewy texture of the bread.

Khorasan or Oriental wheat flour is an ancient grain that is twice the size of modern-day wheat and is known for its rich nutty flavor. Khoransan wheat flour contains 40% more protein than modern wheat, which improves it vitreousness. Khoransan wheat flour is also richer in magnesium, zinc, and selenium, as well as many polyphenols and fatty acids. It comprises up to 65% more amino acids and up to 30% more vitamin E than common bread wheat.

In some instances, a bread formulation is provided comprising a mixture of one or more of einkhorn wheat flour, golden moong flour, dhokla flour, and amaranth seed flour. In other instances, a bread formulation is provided comprising a mixture of einkhorn wheat flour, golden moong flour, dhokla flour, amaranth seed flour, brown rice flour, and corn flour. Other formulations herein further comprise tapioca flour.

Some formulations of the present invention further comprise one or more sweeteners selected from the group consisting of cane juice, cane juice crystals, refined white sugar, stevia, and agave nectar. A dry mixture formulation may include one or more dry sweeteners selected from the group consisting of cane juice crystals, refined white sugar, sucanat, rapidura, date sugar, maple sugar, raw sugar, jiggery, palm sugar, stevia, and natural brown sugar.

The ingredients of the various formulations of the present invention may be combined in any ratio to provide bread having the desired nutritional content and texture discussed herein. In some instances, bread is provided having a protein content from approximately 8-20 grams per serving, wherein one serving is approximately 25-50 grams.

In some instances, the various flours of the instant invention are prepared by grinding the whole bean, whole grain, and/or whole seed of the organisms from which the flour is derived. As such, the entire nutrients of the organisms are provided in the respective flours. Further, by grinding the whole organism the resulting bread comprises a higher fiber content than breads which are not made using the whole organism.

The ingredients of the present invention can be provided in the form of bread mixes with the intention that a consumer can mix and bake them at a convenient, post-purchase time. The ingredients of the present invention can also be provided in the form of pancake and/or waffle mixes with the intention that a consumer can mix and bake them at a convenient, post-purchase time. Thus, bread mixes and pancake mixes are considered to be within the scope of this invention. Similarly, breads can also be provided in the form of bread dough and bread batter with the intention that a consumer can bake them at a convenient, post-purchase time. Thus, bread dough and batter is considered to be within the scope of this invention. Therefore, as used herein, the term “breads” is defined broadly and understood to include bread, bread mixes, bread dough, and bread batter.

In some instances, a formulation for bread is provided which comprises einkhorn wheat flour in an amount that represents approximately 16-30%, 20-25%, 22-24%, or 23.6% v/v of the bread. A bread formulation may also be provided which comprises corn flour in an amount that represents approximately 16-30%, 20-25%, 22-24%, or 23.6% v/v of the bread. Other bread formulations comprise golden moong flour in an amount that represents approximately 5-20%, 8-15%, 10-13%, or 11.8% v/v of the bread. In some instances, a bread formulation is provided which comprises dhokla flour in an amount that represents approximately 5-20%, 8-15%, 10-13%, or 11.8% v/v of the bread. Further, in some instances a bread formulation is provided which comprises amaranth seed flour in an amount that represents approximately 1-15%, 3-12%, 5-10%, or 7.88% v/v of the bread. In other instances, a bread formulation is provided which comprises Khoransan wheat flour in an amount that represent approximately 0-30%, 5-27%, 10-24%, or 23.6% v/v of the bread.

Some formulations of the invention further comprise tapioca flour in an amount that represents approximately 0-15%, 3-12%, 5-10%, or 7.88% v/v of the bread. Further, in some instances a bread formulation is provided which comprises brown rice flour in an amount that represent approximately 0-30%, 5-27%, 10-24%, or 23.6% v/v of the bread.

Ingredients of the present invention may further comprise one or more additional ingredients that are added to the mixture of dry ingredients to provide a bread dough or batter. For example, in some instance one or more eggs are added to the dry mixture, wherein the eggs represent from approximately 0-10.24% v/v of the bread. Coconut oil may further be added to the dry mixture, wherein the coconut oil represents from approximately 0-10.24% v/v of the bread. In other instances, vanilla extract is added to the dry mixture in an amount representing from approximately 0-1.5% v/v of the bread. Baking powder and baking soda may further be added to the dry mixture in amounts representing approximately 1.0% v/v and 0.5% v/v of the bread, respectively.

Some formulations of the instant invention provide a bread mix that may be packaged, labeled and sold. For example, a bread mix may be packaged, labeled and sold as a dry pancake mixture. In some instances, the bread mix or dry pancake mixture is combined with additional ingredients to provide bread dough or pancake batter. For example, the bread mix may be combined with one or more ingredients selected from the group consisting of eggs, water, milk, butter, coconut oil, vegetable oil, macadamia nut oil, and vanilla extract. In other instances, the bread mix is sold to the consumer as a dry bread mix to which the consumer adds additional ingredients to provide a bread dough or batter for subsequent baking.

### EXAMPLES

### Example 1

### High Protein Bread Dry Mix Formulation

| Ingredient | Volume Percent (v/v) |
|---|---|
| Einkhorn Wheat Flour | 23.6 |
| Corn Flour | 23.6 |
| Golden Moong Flour | 11.8 |
| Dhokla Flour | 11.8 |
| Amaranth Seed Flour | 7.9 |
| Cane Juice Crystals | 11.8 |
| Tapioca Flour | 7.9 |
| Baking Powder | 1 |
| Baking Soda | 0.5 |
| Total | 100 |

### Example 2

### High Protein Bread Dough Formulation

| Ingredient | Volume Percent (v/v) |
|---|---|
| Einkhorn Wheat Flour | 17.6 |
| Corn Flour | 17.6 |
| Golden Moong Flour | 8.8 |
| Dhokla Flour | 8.8 |
| Amaranth Seed Flour | 5.8 |
| Cane Juice Crystals | 8.8 |
| Tapioca Flour | 5.8 |
| Baking Powder | 0.73 |
| Baking Soda | 0.36 |
| Water | 17.6 |
| eggs | 3.8 |
| coconut oil | 2.2 |
| vanilla | 2.2 |
| Total | 100 |

### Example 3

### High Protein Pancake Batter Formulation

| Ingredient | Volume Percent (v/v) |
|---|---|
| Einkhorn Wheat Flour | 14.9 |
| Corn Flour | 14.9 |
| Golden Moong Flour | 7.5 |
| Dhokla Flour | 7.5 |
| Amaranth Seed Flour | 5 |
| Cane Juice Crystals | 7.5 |
| Tapioca Flour | 5 |
| Baking Powder | 0.62 |
| Baking Soda | 0.31 |
| Water | 29.9 |
| eggs | 3.2 |
| coconut oil | 1.83 |
| vanilla | 1.83 |
| Total | 100 |

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A high protein bread composition having a formulation comprising einkhorn wheat flour, golden moong flour, dhokla flour, and amaranth seed flour.

2. The composition of claim 1, further comprising brown rice flour.

3. The composition of claim 1, further comprising corn flour.

4. The composition of claim 3, wherein the einkhorn wheat flour represents approximately 16-30% v/v of the composition, the corn flour represents from approximately 16-30% v/v of the composition, the golden moong flour represents approximately 5-20% v/v of the composition, the dholka flour represents approximately 5-20% of the composition, and the amaranth seed flour represents approximately 1-15% v/v of the composition.

5. The composition of claim 4, wherein the einkhorn wheat flour represents approximately 23.6% v/v of the composition, the corn flour represents approximately 20-25% v/v of the composition, the golden moong flour represents approximately 9-15% v/v of the composition, the dholka flour represents approximately 9-15% of the composition, the amaranth seed flour represents approximately 5-10% v/v of the composition, and a sweetener represents approximately 9-10% v/v of the composition.

6. The composition of claim 4, wherein the einkhorn wheat flour represents approximately 20-25% v/v of the composition, the corn flour represents approximately 20-25% v/v of the composition, the golden moong flour represents approximately 9-15% v/v of the composition, the dholka flour represents approximately 9-15% of the composition, the amaranth seed flour represents approximately 5-10% v/v of the composition, eggs represent from 0% to approximately 12% v/v of the composition, tapioca flour represents from 0% to approximately 10% v/v of the composition, water represents from 0% to approximately 12% v/v of the composition, coconut oil represents from 0% to approximately 12% v/v of the composition, vanilla extract represents from 0% to approximately 3% v/v of the composition, baking powder represents from 0% to approximately 2.0% v/v of the composition, and baking soda represents from 0% to approximately 1.0% v/v of the composition.

7. The composition of claim 6, wherein the einkhorn wheat flour represents 23.6% v/v of the composition, the corn flour represents 23.6% v/v of the composition, the golden moong flour represents 11.8% v/v of the composition, the dholka flour represents 11.8% v/v of the composition, the amaranth seed flour represents 7.88% v/v of the composition, and the tapioca flour represents 7.88% v/v of the composition.

8. The composition of claim 1, further comprising a sweetener selected from the group consisting of cane juice, cane juice crystals, refined white sugar, stevia, and agave nectar.

9. The composition of claim 1, further comprising additional ingredients selected from the group consisting of eggs, tapioca flour, water, baking powder, baking soda, coconut oil, and vanilla extract.

10. The composition of claim 1, wherein the high protein bread comprises a pancake.

11. The composition of claim 1, wherein the composition is a bread mix.

12. The composition of claim 1, wherein the composition is a pancake batter.

13. The composition of claim 1, further comprising Khorasan wheat flour.

14. A bread mixture comprising:
einkhorn wheat flour in an amount from approximately 20-25% v/v;
corn flour in an amount from approximately 20-25% v/v;
golden moong flour in an amount from approximately 9-15% v/v;
dhokla flour in an amount from approximately 9-15% v/v; and
amaranth seed flour in an amount from approximately 5-10% v/v.

15. The mixture of claim 14, further comprising a sweetener selected from the group consisting of cane juice, cane juice crystals, refined white sugar, stevia, and agave nectar.

16. The mixture of claim 14, wherein the ingredients are derived from non-genetically modified organisms.

17. The mixture of claim 14, further comprising at least one of a sweetener, eggs, tapioca flour, water, baking powder, baking soda, coconut oil, and vanilla extract.

18. A dry pancake mixture, comprising a formulation of dry ingredients selected from the group consisting of einkhorn wheat flour, corn flour, golden moong flour, dholka flour, amaranth seed flour, brown rice flour, a dry sweetener, tapioca flour, baking powder, and baking soda.

19. The dry mixture of claim 18, further comprising:
einkhorn wheat flour in an amount representing approximately 23.6% v/v of the dry mixture;
corn flour in an amount representing approximately 23.6% v/v of the mixture;
golden moong flour in an amount representing approximately 11.8% v/v of the mixture;
dholka flour in an amount representing approximately 11.8% v/v of the mixture;
amaranth seed flour in an amount representing approximately 7.88% v/v of the mixture;
baking powder in an amount representing approximately 1.0% v/v of the dry mixture; and
baking soda in an amount representing approximately 0.5% v/v of the dry mixture.

20. The dry mixture of claim 18, wherein the dry sweetener is selected from the group consisting of cane juice crystals, refined white sugar, and sucanat, rapidura, date sugar, maple sugar, raw sugar, jiggery, palm sugar, stevia, and natural brown sugar.
